(19) United States
(12) Patent Application Publication
(10) Pub. No.: US 2009/0174916 A1
(43) Pub. Date: Jul. 9, 2009

(54) IMAGE INPUT DEVICE AND IMAGE FORMING DEVICE USING THE SAME

(75) Inventors: Masao Ootsuka, Osaka (JP); Takanori Nakano, Osaka (JP); Noriyuki Tajima, Osaka (JP); Hiroshi Terada, Nara (JP); Terutaka Okamoto, Nara (JP); Hironobu Kinoshita, Fukuoka (JP); Hiroaki Miyaso, Hyogo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/064,701

(22) PCT Filed: Aug. 25, 2006
(86) PCT No.: PCT/JP2006/316763

§ 371 Date: Feb. 25, 2008

(30) Foreign Application Priority Data
Aug. 26, 2005 (JP) 2005-245436

(51) Int. Cl. H04N 1/04

(52) U.S. Cl. 358/498

(57) ABSTRACT

With a small and simple constitution, a three-dimensional subject and a sheet document can be imaged. There are provided an image forming unit (110) for forming an image, an top face sheet ejecting unit (130) for ejecting a paper sheet (P) onto the top face of the device body (101), a top face ejected sheet tray (150) capable of receiving an ejected paper sheet (P) and openable/closable with respect to the device body (101), a platen glass (160) on which a subject is placed, a two-dimensional sensor (170) provided to the top face ejected sheet tray (150) to image the subject placed on the platen glass (160), and a manual feed unit (210) for transporting sheet originals (S) one by one and passing an original through an original information read section. The two-dimensional sensor (170) is so provided that the image of the sheet original appearing in the original information read section is formed on the partial area of the imaging area (170a).

### TECHNOLOGY FIELD

The present invention relates to an image input apparatus capable of imaging a three-dimensional object and reading document information of a sheet document fed automatically, and an image forming apparatus using this image input apparatus, and more particularly to an image input apparatus used by an image forming apparatus such as a monochrome or color copier, printer, or facsimile machine that employs an image forming method such as electrophotography, electrostatic recording, ionography, or magnetic recording.

### BACKGROUND ART

In recent years, MFPs (Multi-Function Peripherals) comprising multifunction all-in-one printers have become widely used. For such MFPs, an image processing apparatus that images a three-dimensional object (hereinafter referred to simply as “image forming apparatus”) has been proposed (see Patent Document 1, for example)

In addition to a USB interface section and an ink-jet printer (hereinafter referred to simply as “printer section”), this image forming apparatus includes an image input apparatus that images a three-dimensional object using a digital camera equipped with a two-dimensional sensor as an imaging section.

A frame for securing the digital camera is attached to the body of such an image forming apparatus so as to extend above the center of the apparatus body. The digital camera is fixed to the frame, and is connected to the apparatus body by a USB cable.

A document placement platform for placing a document that is an object to be imaged, and an operating section manipulated by an operator, are provided on the top of the apparatus body.

At the sides of the apparatus body are provided a paper feed section that feeds paper on which printing (image formation) is performed by a printer section, and a paper ejection section into which paper printed by the printer section is ejected.

This image forming apparatus has three operating modes: copy mode, scanner mode, and printer mode.

In copy mode, image data is input directly from the image input apparatus to the printer section, and copied.

In scanner mode, image data of a document read by the image input apparatus is transferred as RGB (red, green, blue) image data to a computer or the like connected to the image forming apparatus. In printer mode, RGB image data stored in an external computer or the like is read and printed onto paper by the printer section of the apparatus body.

When copy mode is executed, a book or such like three-dimensional object is placed on the document placement platform of the apparatus body, and the object is imaged (scanned) by the digital camera. Then the image data captured by the digital camera is transferred to the printer section of the apparatus body. By this means, image data captured by the digital camera is printed on paper by the printer section, and paper on which the image data has been printed is ejected into the paper ejection section of the apparatus body.

An advantage of this image forming apparatus is that, since an object on the document placement platform is imaged by the digital camera from a distance, the depth of field is great and an image can be captured even if the imaging object is three-dimensional.

### Patent Document 1: Unexamined Japanese Patent Publication No. 2003-348286(FIG. 10)

### DISCLOSURE OF INVENTION

### Problems to be Solved by the Invention

However, a problem with the above-described conventional image forming apparatus is that, since the digital camera serving as an imaging section is fixed to a frame extending above the apparatus body, the apparatus is large.

Also, in order to perform sheet document reading efficiently, it is desirable for an apparatus section to be provided that automatically feeds sheet documents one sheet at a time, and performs imaging using a line sensor extending in a direction orthogonal to the sheet document transportation direction. However, with a conventional image forming apparatus, since the top surface of the apparatus body is a document placement platform for placing an imaging object, such an apparatus section must be installed above the apparatus body, for example, with a resultant problem of the image input apparatus and image forming apparatus becoming still larger.

It is an object of the present invention to provide an image input apparatus and image forming apparatus capable of performing three-dimensional object imaging and sheet document imaging by means of a small and simple configuration.

### Means for Solving the Problems

An image input apparatus of the present invention employs a configuration that includes a document transportation section that moves a sheet document one sheet at a time and passes the sheet document through a predetermined area for imaging, and a two-dimensional sensor that images the sheet document appearing in the predetermined area on a partial area of the imaging area.

### Advantageous Effect of the Invention

According to the present invention, an automatically fed sheet document can be imaged using a partial area of the imaging area of a two-dimensional sensor that images a three-dimensional object. That is to say, it is not necessary to provide a separate line sensor for performing imaging of an automatically fed sheet document, and therefore the apparatus can be made smaller and simpler.

### BRIEF DESCRIPTION OF DRAWINGS

FIG. 1 is a schematic oblique drawing showing the outward appearance of an image forming apparatus according to Embodiment 1 of the present invention;

FIG. 2 is a schematic configuration diagram showing an image forming apparatus according to Embodiment 1 of the present invention in a state in which the top-surface paper ejection tray is open and image information of a book is read;

FIG. 3 is a schematic configuration diagram showing an image forming apparatus according to Embodiment 1 of the present invention in a state in which document information of a sheet document is read;

FIG. 4 comprises three-view drawings showing schematically an example of the outward appearance of a two-dimensional sensor of an image forming apparatus according to Embodiment 1 of the present invention.

FIG. 5 is a circuit configuration diagram showing an example of the circuit configuration of a two-dimensional sensor and peripheral circuitry of an image forming apparatus according to Embodiment 1 of the present invention;

FIG. 6 comprises waveform diagrams showing examples of signal waveforms and timings in a two-dimensional sensor of an image forming apparatus according to Embodiment 1 of the present invention;

FIG. 7 is a schematic configuration diagram showing an image forming apparatus according to Embodiment 2 of the present invention in a state in which a sheet document is fed;

FIG. 8 is a schematic configuration diagram showing an image forming apparatus according to Embodiment 2 of the present invention in a state in which printed paper is ejected;

FIG. 9 is a schematic oblique drawing showing an image forming apparatus according to Embodiment 3 of the present invention in a state in which the top-surface paper ejection tray is open and image information of a book is read;

FIG. 10 is a schematic configuration diagram showing an image forming apparatus according to Embodiment 3 of the present invention in a state in which the top-surface paper ejection tray is open and image information of a book is read;

FIG. 11 is a schematic oblique drawing showing the outward appearance of an image forming apparatus according to Embodiment 4 of the present invention in a state in which the top-surface paper ejection tray is closed;

FIG. 12 is a schematic configuration diagram showing the configuration of an image forming apparatus according to Embodiment 4 of the present invention in a state in which the top-surface paper ejection tray is closed;

FIG. 13 is a schematic oblique drawing showing the outward appearance of an image forming apparatus according to Embodiment 4 of the present invention in a state in which the top-surface paper ejection tray is open;

FIG. 14 is a schematic configuration diagram showing the configuration of an image forming apparatus according to Embodiment 4 of the present invention in a state in which the top-surface paper ejection tray is open;

FIG. 15 is a schematic configuration diagram showing another configuration of an image forming apparatus according to Embodiment 4 of the present invention in a state in which the top-surface paper ejection tray is open and image information of a book is read;

FIG. 16 is a schematic configuration diagram showing another configuration of an image forming apparatus according to Embodiment 4 of the present invention in a state in which the top-surface paper ejection tray is closed and image information of a sheet document is read;

FIG. 17 is a schematic configuration diagram showing another configuration of an image forming apparatus according to Embodiment 4 of the present invention in a state in which the top-surface paper ejection tray is closed and image information of a sheet document is read;

FIG. 18 is a schematic oblique drawing showing an image forming apparatus according to Embodiment 6 of the present invention in a state in which the document feeding apparatus is open and image information of a three-dimensional object is read;

FIG. 19 is a schematic cross-sectional configuration diagram showing an image forming apparatus according to Embodiment 6 of the present invention in a state in which the document feeding apparatus is closed and image information of a sheet document is read;

FIG. 20 is a schematic plan-view configuration diagram showing an image forming apparatus according to Embodiment 6 of the present invention in a state in which the document feeding apparatus is closed and image information of a sheet document is read;

FIG. 21 is a schematic configuration diagram showing the configuration of a camera in a state in which the document feeding apparatus is closed in an image forming apparatus according to Embodiment 6 of the present invention;

FIG. 22 is a schematic configuration diagram showing the configuration of a camera in a state in which the document feeding apparatus is open in an image forming apparatus according to Embodiment 6 of the present invention;

FIG. 23 is a schematic oblique drawing showing an image forming apparatus according to Embodiment 7 of the present invention in a state in which the document feeding apparatus is open and image information of a three-dimensional object is read;

FIG. 24 is a schematic cross-sectional configuration diagram showing an image forming apparatus according to Embodiment 7 of the present invention in a state in which the document feeding apparatus is closed and image information of a sheet document is read; and

FIG. 25 is a schematic plan-view configuration diagram showing an image forming apparatus according to Embodiment 7 of the present invention in a state in which the document feeding apparatus is closed and image information of a sheet document is read.

### BEST MODE FOR CARRYING OUT THE INVENTION

Embodiments of the present invention will now be described in detail with reference to the accompanying drawings. In the drawings, configuration elements and equivalent parts that have identical configurations or functions are assigned the same reference codes, and descriptions thereof are not repeated.

### Embodiment 1

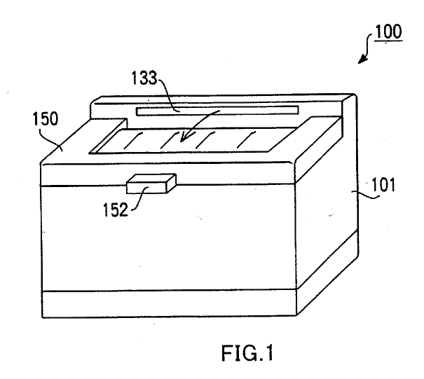

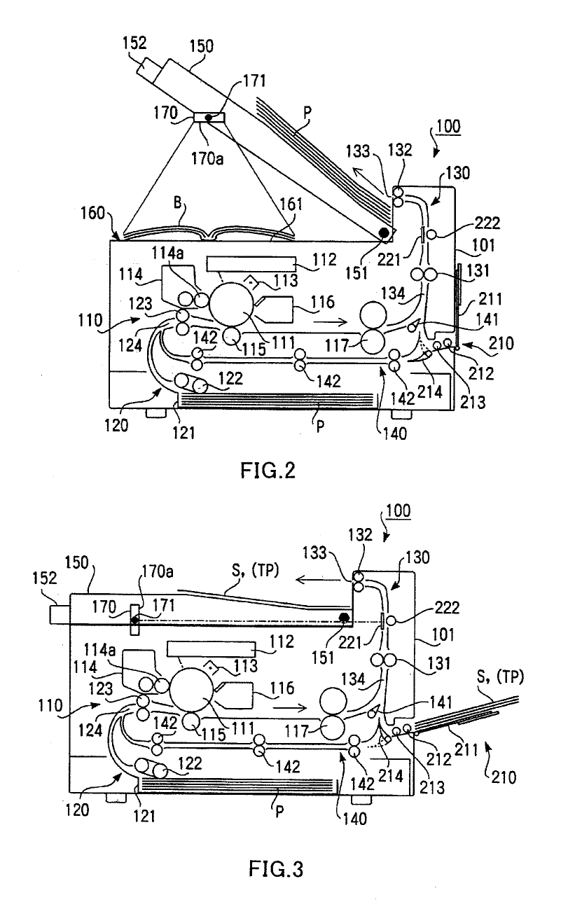

First, an image forming apparatus according to Embodiment 1 of the present invention will be described with reference to FIG. 1, FIG. 2, and FIG. 3. FIG. 1 is a schematic oblique drawing showing the outward appearance of an image forming apparatus according to Embodiment 1 of the present invention, FIG. 2 is a schematic configuration diagram showing an image forming apparatus according to Embodiment 1 of the present invention in a state in which the top-surface paper ejection tray is open and image information of a book is read, and FIG. 3 is a schematic configuration diagram showing an image forming apparatus according to Embodiment 1 of the present invention in a state in which document information of a sheet document is read.

As shown in FIG. 1, FIG. 2, and FIG. 3, image forming apparatus 100 according to Embodiment 1 is provided with an image forming unit 110, a paper feed unit 120, a top-surface paper ejection unit 130, a reverse transportation unit 140, a top-surface paper ejection tray 150, a document placement platform 160, a two-dimensional sensor 170, a manual feed unit 210, and so forth.

Image forming unit 110 is an image forming section that forms (prints) an image on an OHP sheet, printing paper, or suchlike paper P, and is installed inside the apparatus body 101. Image forming unit 110 is composed of a photosensitive drum 111, a laser optical unit 112, an electrifier 113, a developing unit 114, a transfer roller 115, a cleaning unit 116, a fixing unit 117, and so forth.

Developing unit 114 comprises a magnetic brush contact type, two-component development type developing apparatus provided with a magnet roller 114a.

Paper feed unit 120 feeds paper P toward image forming unit 110. Paper feed unit 120 is composed of a paper feed cassette 121, a paper feed roller 122, registration rollers 123, and so forth.

Paper feed cassette 121 holds stacked paper P. Paper feed roller 122 separates and feeds paper P from paper feed cassette 121 one sheet at a time. Registration rollers 123 temporarily halt paper P fed by paper feed roller 122 and then re-feed it at predetermined timing.

Top-surface paper ejection unit 130 is a top-surface paper ejection section that ejects paper P on which an image has been printed by image forming unit 110 (printed paper) onto the top surface of apparatus body 101. Top-surface paper ejection unit 130 is composed of transport rollers 131, top-surface paper ejection rollers 132, a top-surface paper ejection aperture 133, and so forth.

Transport rollers 131 transport paper P on which an image has been printed by image forming unit 110 toward the upper part of apparatus body 101. Top-surface paper ejection rollers 132 eject paper P transported by transport rollers 131 toward the top surface of apparatus body 101. Top-surface paper ejection aperture 133 is provided at the top of apparatus body 101.

When printing images on both sides of paper P, reverse transportation unit 140 reverses the front and back sides of paper P on one side (the surface) of which an image has been printed by image forming unit 110, and transports reversed paper P to image forming unit 110 again. Reverse transportation unit 140 is composed of a paper path switching member (switching lug) 141, reverse transportation rollers 142, and so forth.

Paper path switching member 141 switches the path of paper P on one side (the surface) of which an image has been formed to a reverse transportation path. Reverse transportation rollers 142 perform reverse transportation of paper P sent into the reverse transportation path toward registration rollers 123 of paper feed unit 120.

Top-surface paper ejection tray 150 receives paper ejected by top-surface paper ejection unit 130, and can be opened and closed with respect to apparatus body 101. Top-surface paper ejection tray 150 is supported in a freely pivoting fashion by a spindle 151, and is opened or closed with respect to apparatus body 101 by being raised or lowered by means of a handle 152 provided on the opening and closing side.

Document placement platform 160 allows not only a sheet document but also a three-dimensional object such as a book to be placed upon it. As shown in FIG. 2, document placement platform 160 is configured so that an object placement surface 161 on which an object (here a book B) is placed is exposed by opening top-surface paper ejection tray 150.

Two-dimensional sensor 170 is an imaging section for imaging an object placed on document placement platform 160. Two-dimensional sensor 170 is configured by providing a two-dimensional arrangement of CCD (Charge Coupled Device), CMOS (Complementary Metal Oxide Semiconductor), or suchlike image sensors capable of reading a photographic image of a sheet document, a book or similar bound document, a three-dimensional object, and so forth. Two-dimensional sensor 170 is attached to top-surface paper ejection tray 150. When top-surface paper ejection tray 150 is open with respect to apparatus body 101, two-dimensional sensor 170 is positioned above document placement platform 160, and an imaging area 170a is positioned opposite object placement surface 161 of document placement platform 160 by pivoting two-dimensional sensor 170 about a fulcrum 171. Then, in this state, an optical path from document placement platform 160 to imaging area 170a of two-dimensional sensor 170 is formed by means of an optical system comprising a lens and so forth (not shown), and an image of an object placed on document placement platform 160 is captured on imaging area 170a of two-dimensional sensor 170. This kind of orientation of two-dimensional sensor 170 will be referred to as the first imaging orientation.

Manual feed unit 210 is a manual paper feed section for feeding manual feed paper TP by means of a manual operation by an operator. Manual feed unit 210 is equipped with a manual feed tray 211, a manual pickup roller 212, a manual separating roller 213, and so forth.

Manual feed tray 211 is configured in a foldable manner, and is folded against the side of apparatus body 101 as shown in FIG. 2 when not in use, and extended laterally from apparatus body 101 as shown in FIG. 3 when in use.

Referring to FIG. 2, when an image is formed on paper P fed by paper feed unit 120, an image forming process by means of the well-known electrophotographic method is performed around photosensitive drum 111.

In image forming apparatus 100, the surface of photosensitive drum 111 is first charged to approximately −700 V by means of electrifier 113. Then the surface of photosensitive drum 111 is irradiated with a laser beam by laser optical unit 112 serving as an exposure apparatus, and an electrostatic latent image is formed in accordance with input image information.

When an electrostatic latent image is written to photosensitive drum 111 by laser optical unit 112, the surface potential of exposed image areas is diselectrified to approximately −100 V or below.

Meanwhile, the charge of toner present on magnet roller 114a of developing unit 114 is generally on the order of −20 to −30 uC/g. In this developing unit 114, development is executed by applying AC+DC development voltages, with figures of 4 kHz and 1.6 kVpp for AC and −250 V for DC.

By this means, a toner image is formed by the adhesion of toner to exposed image areas on photosensitive drum 111 which has been diselectrified to approximately −100 V or below.

During this time, paper P stored in paper feed cassette 121 of paper feed unit 120 is fed by paper feed roller 122 to registration rollers 123.

When a toner image formed on photosensitive drum 111 is to be printed on manual feed paper TP fed by means of manual feed unit 210, manual feed tray 211 is extended laterally from apparatus body 101 as shown in FIG. 3, and manual feed paper TP is set on manual feed tray 211.

While a toner image is formed on photosensitive drum 111 after the print start button (not shown) has been pressed, manual feed paper TP set on manual feed tray 211 is separated and fed by means of manual pickup roller 212 and manual separating roller 213, passes along the reverse transportation path of reverse transportation unit 140, and is fed to registration rollers 123 of paper feed unit 120.

Following this, the toner image formed on photosensitive drum 111 is transferred by transfer roller 115 to paper P or manual feed paper TP which has been re-fed by registration rollers 123 at predetermined timing and charged to approximately +500 V.

Then, when paper P or manual feed paper TP passes through fixing unit 117, the toner image adhering to paper P or manual feed paper TP is first melted by the application of heat and pressure, and then fixed to paper P (or manual feed paper TP).

Paper P or manual feed paper TP on which the toner image has been fixed in this way is then ejected onto, and stacked on, top-surface paper ejection tray 150 from top-surface paper ejection aperture 133 provided at the top of apparatus body 101 by top-surface paper ejection rollers 132 of top-surface paper ejection unit 130.

When an object is imaged by two-dimensional sensor 170, if, for example, reading of book B on document placement platform 160 is performed, image input and image forming are performed with top-surface paper ejection tray 150 in an open state, as shown in FIG. 2.

On the other hand, when object reading (object imaging) is not performed by two-dimensional sensor 170, image input and image forming are performed with top-surface paper ejection tray 150 in a closed state, as shown in FIG. 3.

Image forming apparatus 100 can read document information of a sheet document S fed by manual feed unit 210 by means of two-dimensional sensor 170, using manual feed unit 210 as a document feed section. That is to say, a sheet document S automatic feed function is implemented. The configuration of two-dimensional sensor 170 and the document information reading method will be described later herein with reference to separate drawings.

With image forming apparatus 100, when sheet document S document information is to be read by means of two-dimensional sensor 170, manual feed tray 211 of manual feed unit 210 serving as a document feed section is extended from the side of apparatus body 101 as shown in FIG. 3, and sheet document S is placed on manual feed tray 211.

An operating section on the top of apparatus body 101 is provided with a switch (not shown) for switching the paper feed path of manual feed unit 210, and the paper feed mode can be selected by operating this switch. By this means, a paper feed path switching lug 214 moves to a position in which it guides sheet document S into a paper transportation path 134 of top-surface paper ejection unit 130, as shown in FIG. 3, and the paper feed path of manual feed unit 210 is switched.

Then, when a start button (not shown) on the operating section provided on the top of apparatus body 101 is pressed, sheet document S placed on manual feed tray 211 is fed into paper transportation path 134 of top-surface paper ejection unit 130 by manual pickup roller 212 and manual separating roller 213.

Sheet document S fed into paper transportation path 134 of top-surface paper ejection unit 130 then has its document information read by two-dimensional sensor 170 in a nip area (document information reading section) between contact glass 221 and a pressure roller 222 located in paper transportation path 134. Specifically, with top-surface paper ejection tray 150 closed with respect to apparatus body 101, an optical path from the document information reading section to imaging area 170a of two-dimensional sensor 170 is formed by means of an optical system comprising a lens and so forth (not shown) inside apparatus body 101 and top-surface paper ejection tray 150. Then an image of a part of sheet document S appearing in the document information reading section is captured on imaging area 170a of two-dimensional sensor 170 via this optical path by pivoting about fulcrum 171. This kind of orientation of two-dimensional sensor 170 will be referred to as the second imaging orientation. The sections that feed sheet documents S one sheet at a time to the document information reading section, two-dimensional sensor 170, and the sections forming an optical path from the document information reading section to the imaging area of two-dimensional sensor 170, make up an apparatus section (image input apparatus) for performing image input.

Sheet document S whose document information has been read in this way is ejected from top-surface paper ejection aperture 133 onto top-surface paper ejection tray 150 by top-surface paper ejection rollers 132 of top-surface paper ejection unit 130.

When paper P on which an image has been printed by image forming unit 110 is ejected onto top-surface paper ejection tray 150 as shown in FIG. 2, it is desirable for pressure roller 222 to be retracted to a position away from contact glass 221.

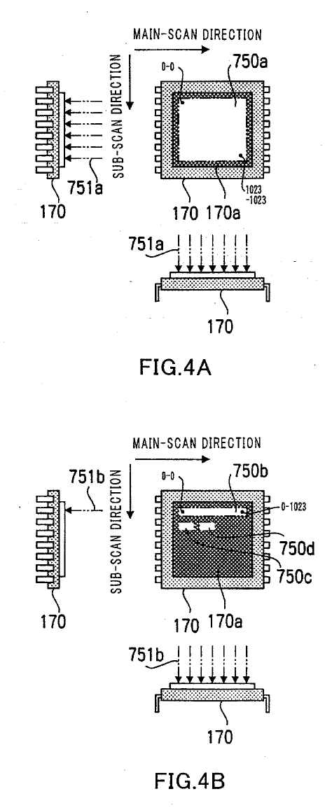

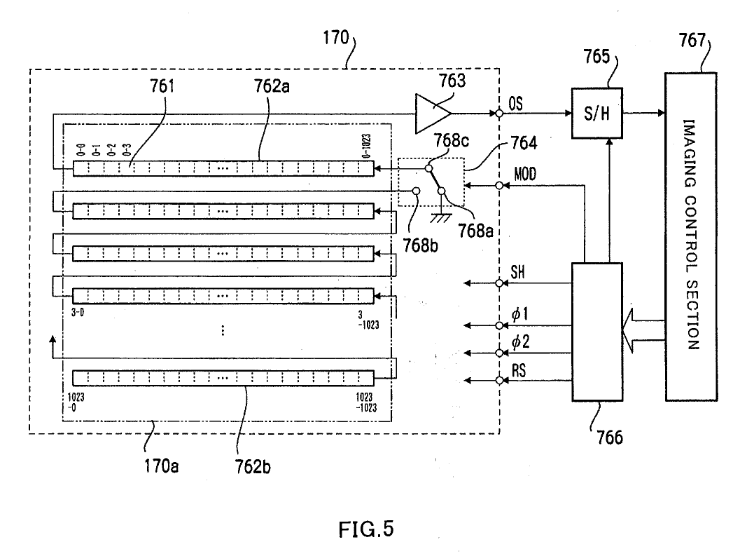

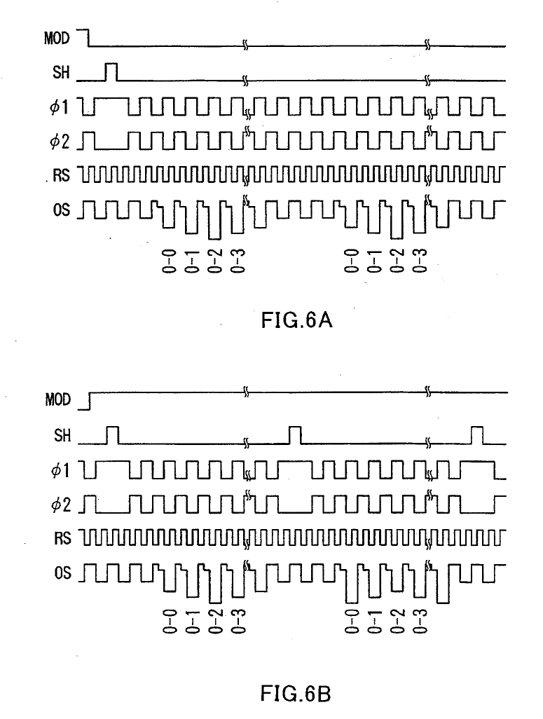

An example of the configuration of two-dimensional sensor 170 and the document information reading method will now be described with reference to FIG. 4, FIG. 5, and FIG. 6.

FIG. 4 comprises three-view drawings showing schematically an example of the outward appearance of two-dimensional sensor 170, FIG. 5 is a circuit configuration diagram showing an example of the circuit configuration of two-dimensional sensor 170 and its peripheral circuitry, and FIG. 6 comprises waveform diagrams showing examples of signal waveforms and timings in two-dimensional sensor 170.

In FIG. 4, FIG. 4A explains the operation of two-dimensional sensor 170 when a three-dimensional object such as a book is used as an imaging object and image information thereof is read (hereinafter referred to as “three-dimensional reading”),as shown in FIG. 2, and FIG. 4B explains the operation when a fed sheet document is used as an imaging object and image information thereof is read (hereinafter referred to as “ADF reading”), as shown in FIG. 3. Below, a direction at right angles to the direction of movement of a sheet document S, and the direction on two-dimensional sensor 170 corresponding thereto, are referred to generically as the main-scan direction, and the direction of movement of a sheet document S, and the direction on two-dimensional sensor 170 corresponding thereto, are referred to generically as the sub-scan direction.

In FIG. 4, it is assumed that two-dimensional sensor 170 has pixels arranged two-dimensionally, and 1,024×1,024 pixels are arranged in the main-scan direction and sub-scan direction respectively. Two-dimensional sensor 170 successively internally transfers and outputs charges generated according to light incident on pixels making up a two-dimensional image by means of a configuration using a CCD as a functional element.

Here, the notations “0-0”, “0-1023”, and “1023-1023” in the figures indicate pixel positions, using the form “(sub-scan-direction ordinal number, an integer starting from 0)-(main-scan-direction ordinal number, an integer starting from 0)”. For example, “0-1023” denotes the position of the 1,023rd pixel in the main-scan direction on the 0'th scan line in the sub-scan direction.

In FIG. 4, imaging area 170a indicated by cross-hatching (including whited-out areas) is the photoreceptive surface of two-dimensional sensor 170.

In FIG. 4A, whited-out photoreceptive area 750a is an area in which, when three-dimensional reading is performed—that is, when two-dimensional sensor 170 has the first imaging orientation—reflected light 751a from the imaging object is incident on two-dimensional sensor 170. That is to say, an image of a three-dimensional object placed on document placement platform 160 is captured in photoreceptive area 750a. In FIG. 4B, whited-out photoreceptive area 750b is an area in which, when ADF reading is performed—that is, when two-dimensional sensor 170 has the second imaging orientation—reflected light 751b from the imaging object is incident on two-dimensional sensor 170. That is to say, an image of a sheet document S positioned in a predetermined area of the document information reading section (hereinafter referred to as a “document information reading area”) is captured in photoreceptive area 750b.

As can be seen from FIG. 4A and FIG. 4B, in three-dimensional reading, photoreceptive area 750a extends over almost all of imaging area 170a, whereas in ADF reading, photoreceptive area 750b is a linear (band-shaped) area comprising only a part of imaging area 170a in the sub-scan direction.

As shown in FIG. 5, two-dimensional sensor 170 is configured internally with 1,024 pixels 761 arranged in the main-scan direction, and 1,024 rows of these pixels 761 (hereinafter referred to as “pixel rows 762”) arranged in the sub-scan direction (equivalent to 1,024 pixels in the sub-scan direction). These pixels 761 form imaging area 170a of two-dimensional sensor 170. Two-dimensional sensor 170 is also equipped with an output section 763.

Among pixel rows 762, pixel row 762a is taken as indicating the 0'th pixel row in the sub-scan direction, and pixel row 762b is taken as indicating the 1,023rd pixel row in the sub-scan direction.

Two-dimensional sensor 170 is equipped with an output section 763 and a mode switching section 764. Also, a sample/hold (S/H) circuit 765, timing control circuit 766, and imaging control section 767, are provided as apparatus sections for performing imaging using two-dimensional sensor 170.

Each pixel 761 of two-dimensional sensor 170 is provided with a transfer section comprising a CCD, and configured (wired) as shown in FIG. 5. That is to say, the transfer sections of pixels 761 are connected in series, and have a function of sequentially sending signal charges generated by the photosensitive sections of pixels 761 to output section 763 (a scanning function). The arrows on the signal lines relating to pixel rows 762 and output section 763 indicate the direction of signal charge transfer when the scanning function is used, and signal charge transfer between pixels 761 is also performed in that direction in each pixel row 762.

Output section 763 of two-dimensional sensor 170 amplifies signal charges sent sequentially from pixels 761, and outputs the resulting signal as an output signal OS.

Mode switching section 764 is for switching between execution of three-dimensional reading and execution of ADF reading by two-dimensional sensor 170. Specifically, mode switching section 764 has a terminal 768a fixed at a certain signal level, a terminal 768b connected to the signal charge output side of the 1st pixel row 762, and a terminal 768c connected to the signal charge input side of 0'th pixel row 762a. Then mode switching section 764 switches and connects terminal 768c to terminal 768b when three-dimensional reading is performed, or to terminal 768a when ADF reading is performed, according to a switching signal MOD described later herein.

Sample/hold circuit 765 samples the level of output signal OS output sequentially from output section 763 of two-dimensional sensor 170 in pixel 761 units at predetermined timing at which output signal OS reaches a level corresponding to the amount of light received by the relevant pixel 761, and holds that level until the next sample is taken. Then sample/hold circuit 765 outputs sequentially the held signal. This signal is a so-called video signal.

Imaging control section 767 has a video signal output from sample/hold circuit 765 as input, and controls the operation of timing control circuit 766. Sheet document S transportation can be controlled by controlling the rollers for paper feeding provided in image forming apparatus 100 in synchronization with the operation of timing control circuit 766.

Timing control circuit 766 outputs a shift signal SH, a transfer signal φ1, a transfer signal φ2, and a reset signal RS, to two-dimensional sensor 170. In addition, timing control circuit 766 outputs switching signal MOD to mode switching section 764, and outputs a signal for performing sampling at the above-mentioned predetermined timing to sample/hold circuit 765.

Shift signal SH causes photosensitive section light sensing and signal charge generation to be performed by each pixel 761 of two-dimensional sensor 170 in an interval between high-level pulses, and thereafter causes signal charge transfer to the respective transfer sections.

Transfer signals φ1 and φ2 causes the sequential transfer to output section 763 of signal charges of pixels 761 transferred to the transfer sections by means of shift signal SH (scanning function).

Reset signal RS performs initialization of the transfer section of each pixel 761 each time transfer is completed for one pixel, in synchronization with transfer signals φ1 and φ2. Specifically, each time transfer is completed for one pixel, at the point of completion reset signal RS discharges an accumulated charge for a capacitor for pixel-unit signal charge detection provided in the transfer section of each pixel 761.

Switching signal MOD switches the connection state of mode switching section 764 so that three-dimensional reading is performed in a low-level interval and ADF reading is performed in a high-level interval.

FIG. 6A shows the output timing of the signals in the case of three-dimensional read operation, and FIG. 6B shows the output timing of the signals in the case of ADF read operation.

First, three-dimensional read operation will be described with reference to FIG. 6A. It is here assumed that a three-dimensional object such as a book for which image information reading is to be performed has been placed on document placement platform 160 by the user, and a read start directive has been given to imaging control section 767.

In three-dimensional reading, image forming apparatus 100 performs imaging using all pixels 761 of imaging area 170a (0'th pixel row 762a through 1,023rd pixel row 762b—that is, pixel [0-0] through pixel [1023-1023]). Therefore, imaging control section 767 causes timing control circuit 766 to set switching signal MOD to the low level, and causes terminal 768c of mode switching section 764 of two-dimensional sensor 170 to be connected to terminal 768b.

Then imaging control section 767 causes timing control circuit 766 to output a shift signal SH high-level pulse.

When a shift signal SH high-level pulse is input, two-dimensional sensor 170 causes the signal charge generated by light sensing by the photosensitive section of each pixel 761 up to that time to be transferred to the respective transfer section. The first signal charge obtained after the start of a read operation is not necessarily such that previous signal timings meet a predetermined condition at that time. Therefore, imaging control section 767 skips a video signal output in response to the first shift signal SH high-level pulse output. Thus, the following description relates to output of the second shift signal SH high-level pulse onward.

Next, imaging control section 767 causes transfer signals φ1 and φ2 having a predetermined period and reset signal RS to be output to two-dimensional sensor 170.

The transfer section of each pixel 761 of two-dimensional sensor 170 transfers a transferred pixel 761 signal charge for one pixel to the output section 763 side. Then, each time a one-pixel transfer is completed, the above-described capacitor is initialized by a high-level pulse of reset signal RS.

Then two-dimensional sensor 170 performs the same kind of operation for each period of transfer signals φ1 and φ2, and ultimately, signal charge transfer is performed for all the pixels of imaging area 170a (pixel rows 762a through 760b). That is to say, the above operations are repeated while output section 763 performs signal output starting with pixel [0-0], and then through pixel [0-1] up to pixel [1023-1023].

At this time, sample/hold circuit 765 samples output section 763 output (the video signal) every transfer signal φ1 and φ2 period, the periods in which pixels 761 are shown. Then imaging control section 767 sequentially reads the sample/hold circuit 765 output signal every transfer signal φ1 and φ2 period as a per-pixel 761 video level (level corresponding to the amount of light received)

As shown in FIG. 6A, output section 763 output includes a signal that does not show a level corresponding to the amount of light received by a pixel 761 at the start and end timings of each pixel row 762. Imaging control section 767 ignores and skips such signals. For convenience, in this description it will be assumed that there are no signals that do not show a level corresponding to the amount of light received.

By means of the above operations, imaging control section 767 performs control for imaging using photoreceptive area 750a shown in FIG. 4A—that is, almost all of imaging area 170a. Then, through this control, two-dimensional sensor 170 outputs a video signal corresponding to photoreceptive area 750a, and imaging control section 767 performs reading of image information corresponding to photoreceptive area 750a and implements three-dimensional reading.

Next, ADF read operation will be described with reference to FIG. 6B. It is here assumed that a document comprising a plurality of sheet documents S for which image information reading is to be performed has been placed on manual feed tray 211 of manual feed unit 210 by the user, and a read start directive has been given to imaging control section 767. It is also assumed that one sheet document S has been transported to the document information reading section comprising contact glass 221 and pressure roller 222.

In ADF reading, image forming apparatus 100 performs imaging using only 0'th pixel row 762a from among 0'th pixel row 762a through 1,023rd pixel row 762b of imaging area 170a. Therefore, imaging control section 767 sets switching signal MOD to the high level, and causes terminal 768c of mode switching section 764 of two-dimensional sensor 170 to be connected not to terminal 768b but to terminal 768a. That is to say, of 0'th pixel row 762a through 1,023rd pixel row 762b, only 0'th pixel row 762a is connected to output section 763.

Here, terminal 768a is assumed to be fixed at a given signal level as stated above, this being to prevent a signal of indeterminate level from being transferred to output section 763.

Then, as in the description referring to FIG. 6A, imaging control section 767 causes timing control circuit 766 to output a shift signal SH high-level pulse, transfer signals φ1 and φ2, and reset signal RS. As a result, signal charges of pixels 761 are transferred sequentially to the output section 763 side. However, the above operation is performed only for one pixel row—that is, for all the pixels of pixel row 762a (pixel [0-0] through pixel [0-1023]).

By means of such operation, imaging control section 767 performs control for imaging using photoreceptive area 750b shown in FIG. 4B—that is, one pixel row. Then, through this control, two-dimensional sensor 170 outputs a video signal corresponding to photoreceptive area 750b, and imaging control section 767 performs reading of image information corresponding to photoreceptive area 750b—that is, image information of a part of the document surface of sheet document S located in the above-described document information reading section.

When reading of image information of one pixel row is performed, imaging control section 767 next transports (feeds) sheet document S in the document information reading section by a width corresponding to one pixel row, and causes timing control circuit 766 to output an above-described shift signal SH high-level pulse again. Then imaging control section 767 causes output of transfer signals φ1 and φ2 and reset signal RS in the same way as when causing output of the previous shift signal SH high-level pulse. Imaging control section 767 then repeats the above operations for the entire extent of the document surface of sheet document S, and performs two-dimensional image combining by arranging the obtained video signals of each pixel row in pixel row order. Imaging control section 767 outputs the image data generated in this way as sheet document S document surface image data.

Thus, imaging control section 767 repeatedly obtains partial data corresponding to the document information reading area from the image data output by two-dimensional sensor 170—that is, only data for a partial extent of the document surface of a sheet document S—in synchronization with the speed of movement of that sheet document S. Then imaging control section 767 performs two-dimensional combining of the obtained image data for a plurality of extents, giving image data of the entire surface. By this means, imaging can also be performed for a moving sheet document S using two-dimensional sensor 170.

In this embodiment, in ADF reading, imaging has been assumed to be performed using only pixel row 762a, the 0'th row in the main-scan direction, within imaging area 170a of two-dimensional sensor 170, but another area of imaging area 170a may also be used. For example, if, in the configuration of the optical path from the document information reading area to two-dimensional sensor 170, the length of the document information reading area in the sub-scan direction on the document surface of a sheet document S (the band width of the band-shaped document information reading area) is further extended, pixel rows used in imaging can be made the 0'th row and a plurality of succeeding rows according to that length. At this time, after image information reading has been performed for a plurality of pixel rows, a sheet document S in the document information reading section need only be transported (fed) by an amount equivalent to that plurality of rows—that is, by the band width of the document information reading area.

By means of such a configuration, imaging of a wider area can be performed in one imaging operation, enabling ADF reading to be speeded up according to the imaging speed of two-dimensional sensor 170 and the speed of the resultant video signal output.

It is also possible to perform sheet document S transportation (feeding) in the document information reading section in steps equivalent to one pixel row of two-dimensional sensor 170, and to perform imaging using a plurality of pixel rows on such a step-by-step basis. Then, based on the plurality of images repeatedly captured by means of such paper feeding and imaging, it may be determined whether or not content image variation among that plurality of images is synchronized with paper feeding. The result of this determination will then enable slippage in sheet document S transportation and so forth to be detected.

Specifically, for example, provision is made for an image of a sheet document S positioned in an area that is of the same length in the sub-scan direction as the document information reading area and is adjacent in the sub-scan direction of the document information reading area (hereinafter referred to as “adjacent area”) to be captured on imaging area 170a of two-dimensional sensor 170. Then each time sheet document S is moved by the band width of the document information reading area, imaging is performed for the document information reading area and adjacent area. In this case, as long as the speed of movement of sheet document S and the imaging timing are synchronized, the same area of sheet document S will be imaged twice in the document information reading area and adjacent area, with an interval equivalent to one imaging operation therebetween.

That is to say, whether or not the sheet document S speed of movement and the imaging timing are synchronized can be determined by comparing an image captured in the document information reading area and an image captured in an adjacent area one imaging operation apart. It is desirable for this determination to be made at timing such that the image data arrangements (hereinafter referred to as “line patterns”) are different for the document information reading area and the adjacent area.

Even if adequately precise synchronization is achieved, line patterns being considered may actually show slight differences in each captured image. This can be handled by implementing practically appropriate detection precision by rounding minute differences to a certain degree in line pattern comparisons. Furthermore, if the above-described band width is extended, many images to be captured in synchronization with sheet document S transportation (feeding) can be obtained, and line patterns and their average movement can be calculated with a high degree of precision based on these many images. That is to say, the precision of the above-described determination can be improved

For a pixel row used for imaging in ADF reading, a signal charge of each pixel is transferred sequentially by an internal transfer section, and considering the time until a signal of a desired pixel is output from output section 763, it is preferable to use a pixel row located nearer output section 763. In view of this, the 0'th pixel row is used for imaging in this embodiment, but this need not necessarily be the case, and any pixel row within imaging area 170a may be used. For example, the 3rd row, or the 3rd row and a plurality of succeeding rows, may be used. In this case, provision should be made for imaging control section 767 to image only a pixel row corresponding to a part used for imaging among the input image data—that is, only a pixel row corresponding to the document information reading section.

In the above description, a case has been described in which imaging is performed using only photoreceptive area 750b in ADF reading, but sheet document S size detection or the like may also be performed using photoreceptive area 750c and photoreceptive area 750d as well, as shown in FIG. 4B.

Specifically, for example, provision may be made for an image of an area that both an A4 size sheet document S and an A3 size sheet document S pass, within an area on the sheet document S transportation path, to be captured in photoreceptive area 750d. On the other hand, provision may be made for an image of an area that an A3 size sheet document S passes but an A4 size sheet document S does not pass, within an area on the sheet document S transportation path, to be captured in photoreceptive area 750c. By this means it is possible to detect the size of sheet documents S passing through the document information reading section based on images captured by photoreceptive areas 750c and 750d. That is to say, it is possible to detect the size of a sheet document S without providing a separate special-purpose sensor.

Furthermore, if an optical fiber is used as an optical path from an area subject to detection to photoreceptive areas 750c and 750d, photoreceptive areas 750c and 750d and the area subject to detection can be positioned with greater flexibility.

Of course, photoreceptive areas 750c and 750d need not necessarily be arranged discontinuously as shown in FIG. 4B, but may also be arranged continuously. In this case, in image data reading, there is no place (data) to be skipped between photoreceptive area 750c and photoreceptive area 750d on the imaging control section 767 side, and therefore processing can be performed efficiently. Similarly, photoreceptive areas 750c and 750d and photoreceptive area 750b need not necessarily be arranged discontinuously as shown in FIG. 4B, but may also be arranged continuously.

As described above, in image forming apparatus 100 of this embodiment, paper P on which an image has been formed is ejected onto top-surface paper ejection tray 150 located on the top of apparatus body 101. Thus, the paper ejection section does not project from the side of apparatus body 101, enabling the footprint of the apparatus to be made smaller, and an operation to remove ejected paper P to be performed easily.

Also, in image forming apparatus 100 of this embodiment, top-surface paper ejection tray 150 also functions as a support for two-dimensional sensor 170. Thus, it is not necessary to provide a frame or the like above apparatus body 101 to support two-dimensional sensor 170, and the overall apparatus is not thereby made larger.

Moreover, reading of an automatically fed sheet document S can also be performed using two-dimensional sensor 170 for performing imaging of a three-dimensional object such as a book, and it is therefore not necessary to provide a separate line sensor for reading an automatically fed sheet document. Thus, reading of image information of a three-dimensional object such as a book, and reading of image information of a sheet document using an ADF function, can both be implemented with a small and simple configuration, and the apparatus can be made less expensive.

Furthermore, in image forming apparatus 100 of this embodiment, when ADF reading is performed, imaging is performed repeatedly for the entire extent of the document surface of a sheet document S, and two-dimensional image combining is performed by arranging the images in order, enabling the imaging area to be made smaller. That is to say, the space required for an optical path from the document information reading section to two-dimensional sensor 170 can be made smaller. Also, when ADF reading is performed, this space can be further decreased by performing imaging using only some of the pixel rows of two-dimensional sensor 170.

### Embodiment 2

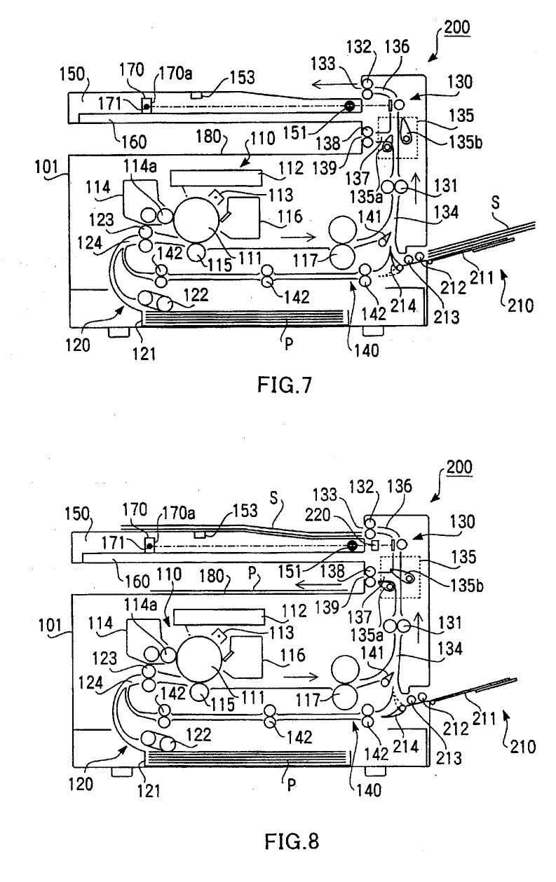

Next, an image forming apparatus according to Embodiment 2 of the present invention will be described with reference to FIG. 7 and FIG. 8. FIG. 7 is a schematic configuration diagram showing an image forming apparatus according to Embodiment 2 of the present invention in a state in which a sheet document is fed, and FIG. 8 is a schematic configuration diagram showing an image forming apparatus according to Embodiment 2 of the present invention in a state in which printed paper is ejected.

In image forming apparatus 100 according to Embodiment 1, paper P printed by means of image forming unit 110 and a sheet document S fed by means of manual feed unit 210 are both ejected onto top-surface paper ejection tray 150.

Therefore, with image forming apparatus 100, when sheet documents S and paper P are ejected in a mixed manner onto top-surface paper ejection tray 150, it is necessary to carry out the task of separating sheet documents S and paper P.

Thus, in an image forming apparatus 200 of Embodiment 2, an intra-body paper ejection tray 180 is formed in the housing of apparatus body 101 as shown in FIG. 7 and FIG. 8. Paper transportation path 134 that ejects paper P or a sheet document S can be switched between a top-surface paper ejection path 136 that performs ejection onto top-surface paper ejection tray 150, and an intra-body paper ejection path 137 that performs ejection onto intra-body paper ejection tray 180.

Switching of paper transportation path 134 is performed by means of switching lugs 135a and 135b of a paper transportation path switching unit 135 serving as a paper transportation path switching section.

By this means, the paper ejection destination can be switched arbitrarily between top-surface paper ejection tray 150 and intra-body paper ejection tray 180. Specifically, for example, a sheet document S fed by means of manual feed unit 210 passes along top-surface paper ejection path 136 and is ejected onto top-surface paper ejection tray 150 from top-surface paper ejection aperture 133 by means of top-surface paper ejection rollers 132 as shown in FIG. 7, whereas paper P printed by means of image forming unit 110 passes along intra-body paper ejection path 137 and is ejected onto intra-body paper ejection tray 180 from an intra-body paper ejection aperture 139 by means of intra-body paper ejection rollers 138 as shown in FIG. 8. By this means, the task of separating different types of paper after ejection can be alleviated.

It is also possible for a sheet document S fed by means of manual feed unit 210 to be ejected onto intra-body paper ejection tray 180, and for paper P printed by means of image forming unit 110 to be ejected onto top-surface paper ejection tray 150.

Thus, with image forming apparatus 200 of this embodiment, sheet documents S and paper P can be differentiated in advance for ejection onto top-surface paper ejection tray 150 and intra-body paper ejection tray 180 respectively, enabling ejected sheet documents S and paper P to be easily distinguished from each other.

If sheet documents S read in a previous job are left on top-surface paper ejection tray 150, when sheet documents S read in the next job are ejected onto top-surface paper ejection tray 150, sheet documents S of different jobs will be mixed together.

Therefore, if sheet documents S of different jobs are ejected in a mixed manner onto top-surface paper ejection tray 150, it will be necessary to separate the mixed sheet documents S, and workability will decline.

Thus, in image forming apparatus 200, a document detection sensor 153 is provided as a document detection section that detects the presence or absence of a sheet document S ejected onto top-surface paper ejection tray 150. A configuration is employed such that, if document 5 detection sensor 153 detects a sheet document S ejected onto top-surface paper ejection tray 150, paper transportation path 134 is switched by paper transportation path switching unit 135 so that a sheet document S read in the next job is ejected toward intra-body paper ejection tray 180.

That is to say, with image forming apparatus 200 of this embodiment, a sheet document S fed by means of manual feed unit 210 is normally ejected onto top-surface paper ejection tray 150 as shown in FIG. 7, but if document detection sensor 153 detects a sheet document S ejected onto top-surface paper ejection tray 150, paper transportation path 134 is switched by paper transportation path switching unit 135 so that a sheet document S read in the next job is ejected toward intra-body paper ejection tray 180.

By this means, with image forming apparatus 200, if a sheet document S read in a previous job is left on top-surface paper ejection tray 150, a sheet document S read in the next job is ejected onto intra-body paper ejection tray 180.

Therefore, with image forming apparatus 200 of this embodiment, sheet documents S of different jobs can be differentiated in advance for ejection, and mixing of sheet documents S of different jobs can be prevented.

### Embodiment 3

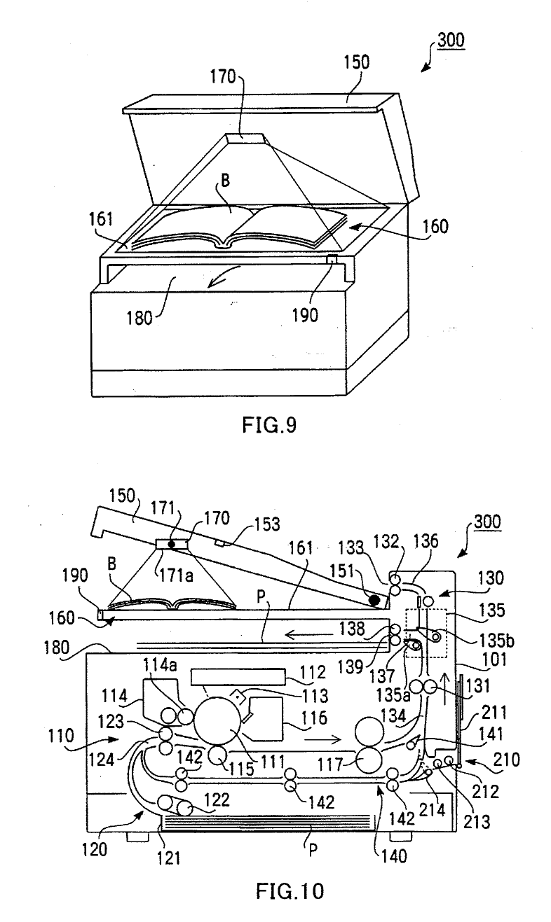

Next, an image forming apparatus according to Embodiment 3 of the present invention will be described with reference to FIG. 9 and FIG. 10. FIG. 9 is a schematic oblique drawing showing an image forming apparatus according to Embodiment 3 of the present invention in a state in which the top-surface paper ejection tray is open and image information of a book is read, and FIG. 10 is a schematic configuration diagram showing an image forming apparatus according to Embodiment 3 of the present invention in a state in which the top-surface paper ejection tray is open and image information of a book is read.

With image forming apparatus 200 according to Embodiment 2, there is a possibility of a paper jam occurring if printed paper P is ejected onto top-surface paper ejection tray 150 when top-surface paper ejection tray 150 is opened widely as shown in FIG. 9.

Thus, as shown in FIG. 9 and FIG. 10, in an image forming apparatus 300 of this embodiment a tray open/closed detection sensor 190 is provided as a tray open/closed detection section that detects the open or closed state of top-surface paper ejection tray 150.

Then, when tray open/closed detection sensor 190 of image forming apparatus 300 detects that top-surface paper ejection tray 150 is open, paper transportation path 134 that ejects paper P or sheet documents S is switched to intra-body paper ejection path 137 by paper transportation path switching unit 135.

By this means, when top-surface paper ejection tray 150 of image forming apparatus 300 of this embodiment is opened widely, paper P or a sheet document S passes along intra-body paper ejection path 137 and is ejected from intra-body paper ejection aperture 139 onto intra-body paper ejection tray 180 by intra-body paper ejection rollers 138, thereby preventing the occurrence of an ejected paper P or sheet document S paper jam.

### Embodiment 4

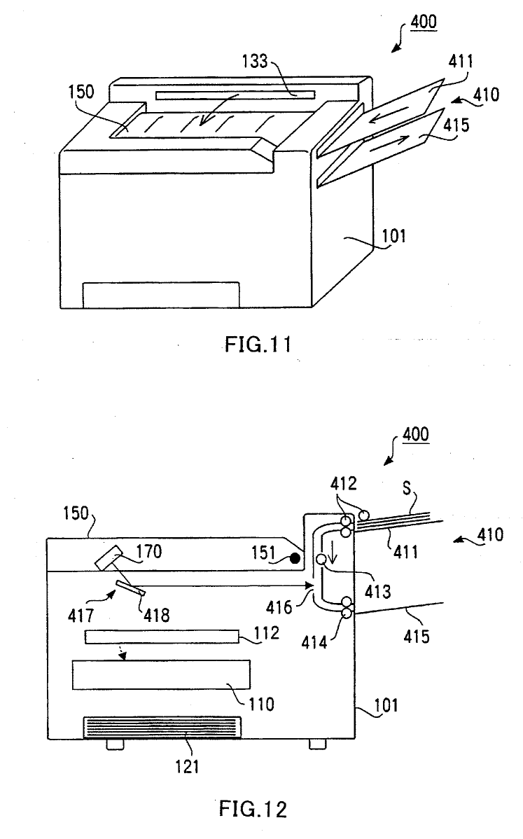

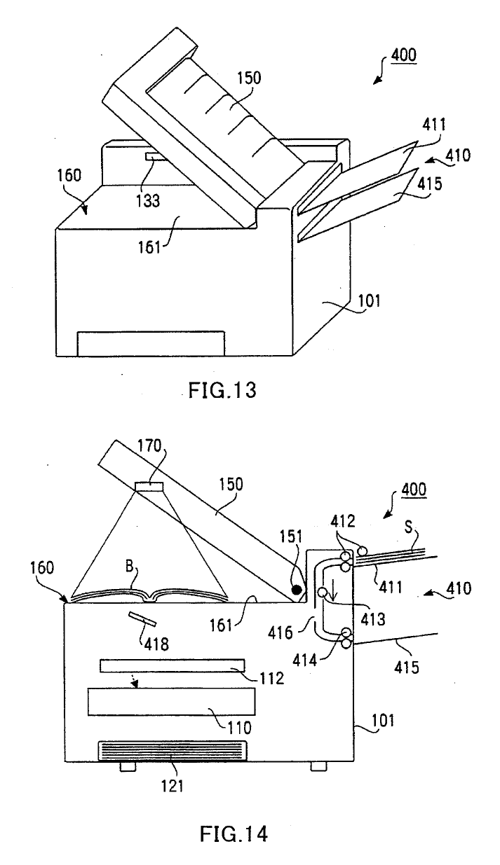

Next, an image forming apparatus according to Embodiment 4 of the present invention will be described with reference to FIG. 11, FIG. 12, FIG. 13, and FIG. 14. FIG. 11 is a schematic oblique drawing showing the outward appearance of an image forming apparatus according to Embodiment 4 of the present invention in a state in which the top-surface paper ejection tray is closed, FIG. 12 is a schematic configuration diagram showing the configuration of an image forming apparatus according to Embodiment 4 of the present invention in a state in which the top-surface paper ejection tray is closed, FIG. 13 is a schematic oblique drawing showing the outward appearance of an image forming apparatus according to Embodiment 4 of the present invention in a state in which the top-surface paper ejection tray is open, and FIG. 14 is a schematic configuration diagram showing the configuration of an image forming apparatus according to Embodiment 4 of the present invention in a state in which the top-surface paper ejection tray is open.

As shown in FIG. 11 and FIG. 12, an image forming apparatus 400 of this embodiment is provided with an automatic document feeder (ADF) 410 that performs feeding of sheet documents S.

Automatic document feeder 410 is composed of a document feed tray 411, document feed rollers 412, a document guide roller 413, document ejection rollers 414, a document ejection tray 415, and so forth.

In FIG. 11 and FIG. 12, sheet documents S are stacked on document feed tray 411. Sheet documents S stacked on document feed tray 411 are separated and fed one sheet at a time by document feed rollers 412.

A sheet document S separated and fed by document feed rollers 412 is transported by document guide roller 413 to a document information reading section 416 that reads document information of a sheet document.

As shown in FIG. 12, image forming apparatus 400 has a document reading optical system 417 whereby document information of a sheet document S transported to document information reading section 416 is read by means of two-dimensional sensor 170.

Document reading optical system 417 is configured so that document information of a sheet document S transported to document information reading section 416 is read by two-dimensional sensor 170 fixed to top-surface paper ejection tray 150 in the closed state using a reflecting mirror 418. That is to say, document reading optical system 417 is configured so that an image of a sheet document S in document information reading section 416 is captured in a partial area of imaging area 170a of two-dimensional sensor 170.

By this means, in image forming apparatus 400 of this embodiment, a special-purpose scanner is not provided in automatic document feeder 410, and two-dimensional sensor 170 is given the above-described second imaging orientation while top-surface paper ejection tray 150 is in the closed state, and therefore document information of a plurality of sheet documents S can be read (scanned) continuously by imaging two-dimensional sensor 170.

A sheet document S whose document information has been read by document information reading section 416 is then ejected onto document ejection tray 415 by document ejection rollers 414.

As shown in FIG. 13 and FIG. 14, a document that cannot be fed by means of automatic document feeder 410 (such as a book B, for example) is placed on object placement surface 161 of document placement platform 160 exposed by opening top-surface paper ejection tray 150, and imaged by two-dimensional sensor 170.

In image forming apparatus 400, document information of-a sheet document S transported to document information reading section 416 is read by two-dimensional sensor 170 fixed to top-surface paper ejection tray 150 in a closed state using reflecting mirror 418.

However, doing so requires the use of reflecting mirror 418 for reading image information of a sheet document S by means of two-dimensional sensor 170.

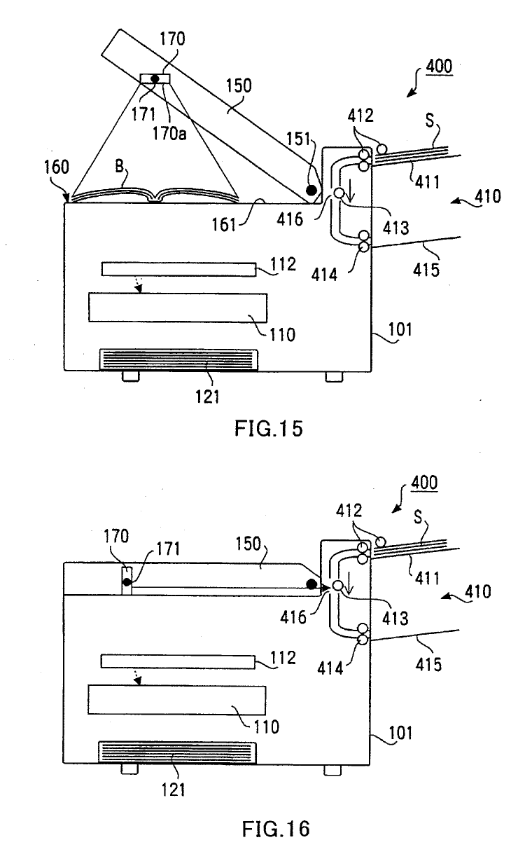

Thus, in image forming apparatus 400 of this embodiment, provision may also be made for a document to be read by pivoting two-dimensional sensor 170 about fulcrum 171 as shown in FIG. 15 and FIG. 16.

That is to say, when a document that cannot be fed by means of automatic document feeder 410 (such as book B, for example) is read, two-dimensional sensor 170 is rotated so that imaging area 170a of two-dimensional sensor 170 faces object placement surface 161 of document placement platform 160 as shown in FIG. 15. By this means, two-dimensional sensor 170 is given the above-described second imaging orientation.

Then, when document information of a sheet document S transported to document information reading section 416 of automatic document feeder 410 is read, two-dimensional sensor 170 located on top-surface paper ejection tray 150 in the closed state is rotated to an attitude facing document information reading section 416, as shown in FIG. 16. By this means, two-dimensional sensor 170 is given the above-described first imaging orientation.

In this case, two-dimensional sensor 170 is configured so as to be rotated through a predetermined angle of opening (such as an angle of approximately 45°, for example) about fulcrum 171 and latched by a rotating and latching section (not shown).

With this kind of configuration, document reading optical system 417 using reflecting mirror 418 as shown in FIG. 12 is unnecessary, enabling the configuration to be simplified.

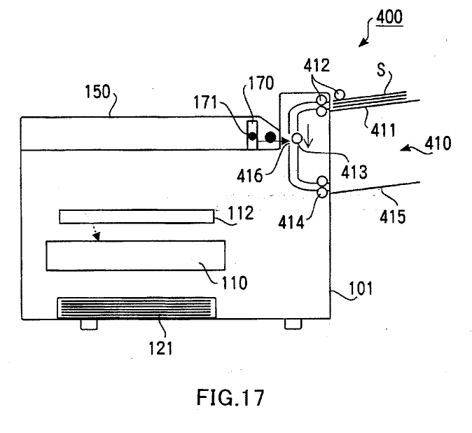

Provision may also be made for two-dimensional sensor 170 of this example to be rotated to an attitude facing document information reading section 416 and moved to a reading position close to document information reading section 416 by means of a moving and latching section (not shown), and there read sheet document S document information, as shown in FIG. 17. That is to say, two-dimensional sensor 170 may be brought closer to document information reading section 416 in the second imaging orientation than in the first imaging orientation. By this means, the optical path from document information reading section 416 to two-dimensional sensor 170 can be shortened, and it is possible to decrease the space for providing an optical path, simplify the optical system, and improve reading precision. Also, images of a sheet document S positioned in document information reading section 416 may be captured on imaging area 170a at a plurality of different positions. In this case, the size of a sheet document S image captured on imaging area 170a can be made variable, and the number of pixels in a sheet document S read can be made variable.

### Embodiment 5

Next, an image forming apparatus according to Embodiment 5 of the present invention will be described.

As shown in Embodiment 1, when a book is imaged from above using a two-dimensional sensor attached to the ejection tray, the book is placed on the document placement platform opened and with its pages facing upward.

In this case, since the book surface to be imaged is facing upward, it is easy for the user to check the imaged surface. Also, when a plurality of double-page spreads are imaged successively, pages can be turned easily without having to move or turn over the entire book. Therefore, when imaging a plurality of double-page spreads of a book, the imaging task can be completed in a shorter time by using a two-dimensional sensor attached to the ejection tray.

However, the user must perform the tasks of turning the page and pressing the start button each time a new double-page spread is imaged, which is a laborious and time-consuming process. When the number of pages to be imaged is large, in particular, the user has to stay by the image forming apparatus for a lengthy period.

Thus, an image forming apparatus according to Embodiment 5 of the present invention is equipped with an automatic page-turning device (automatic page-turner) that automatically turns the pages of an opened and upturned book placed on the document placement platform in synchronization with imaging timing.

Many automatic page-turners have already appeared on the market as stand-alone products. For example, an automatic page-turner may have a configuration comprising a plurality of levers each of which performs an independent operation. More specifically, an automatic page-turner may have, for example, a configuration comprising two page-pressing levers located at the left and right of the pages, a page-raising lever having rubber or the like at its tip, and a page-turning lever that operates in the manner of a windshield wiper.

An example of the operation of an automatic page-turner having such a configuration will now be described.

First, when securing and imaging a page, the two page-pressing levers press against the left and right pages so that the pages do not move, and the page-raising lever and page-turning lever are retracted to positions in which they do not interfere with the imaging process.

Then, after imaging by the two-dimensional sensor is completed, the tip of the page-raising lever catches the edge of the page to be turned, and raises the page. The page-turning lever is then inserted beneath the raised part of the page, and operating in the manner of a windshield wiper, slides under the page-pressing lever on the side opposite the side on which the page is raised. By this means, the page is turned. The page-raising lever and page-turning lever then move back to their retracted positions again, and preparations are made for the next imaging operation.

In this way, the time and effort involved in manual page turning by a user can be saved, pages can be turned more quickly, and the imaging time can be shortened.

Thus, in an image forming apparatus of this embodiment, the provision of an automatic page-turner on the document placement platform enables a plurality of pages to be imaged more quickly and efficiently when imaging a book or the like by means of a two-dimensional sensor.

### Embodiment 6

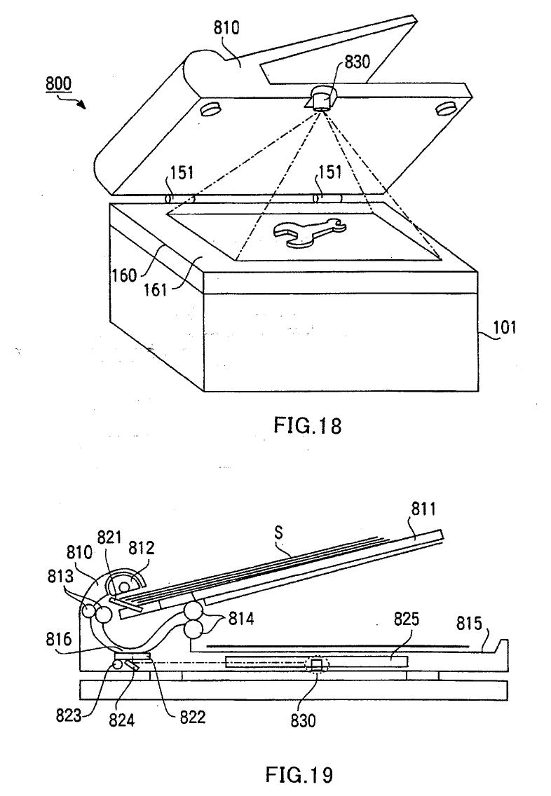

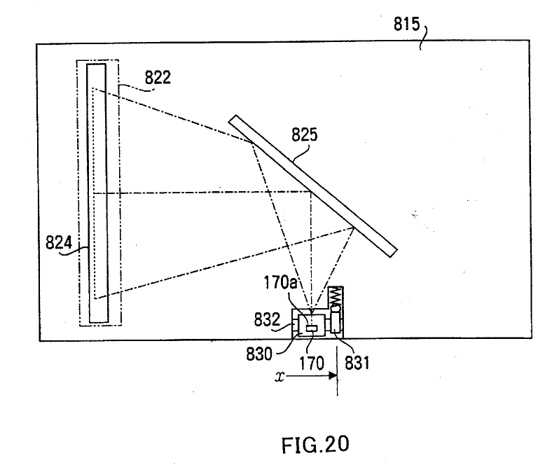

Next, an image forming apparatus according to Embodiment 6 of the present invention will be described with reference to FIG. 18, FIG. 19, and FIG. 20. FIG. 18 is a schematic oblique drawing showing an image forming apparatus according to Embodiment 6 of the present invention in a state in which the document feeding apparatus is open and image information of a three-dimensional object is read, FIG. 19 is a schematic cross-sectional configuration diagram showing an image forming apparatus according to Embodiment 6 of the present invention in a state in which the document feeding apparatus is closed and image information of a sheet document is read, and FIG. 20 is a schematic plan-view configuration diagram showing an image forming apparatus according to Embodiment 6 of the present invention in a state in which the document feeding apparatus is closed and image information of a sheet document is read.

As shown in FIG. 18, an image forming apparatus 800 according to Embodiment 6 of the present invention is equipped with an apparatus body 101, a document placement platform 160, a document feeding apparatus 810, a camera 830, and so forth. Document feeding apparatus 810 feeds sheet documents S one sheet at a time, and can be opened and closed with respect to document placement platform 160 by means of spindles 151 such as hinges provided on one side of document feeding apparatus 810. Spindles 151 are installed on one side of document feeding apparatus 810 parallel to the direction of movement of sheet documents S.

Document feeding apparatus 810 is normally closed, but is opened upward to expose object placement surface 161 when imaging a three-dimensional object such as a book. Camera 830 incorporating a two-dimensional sensor is attached to the center part of the opening/closing edge of document feeding apparatus 810.

When document feeding apparatus 810 is opened by the user in order to perform three-dimensional reading, document feeding apparatus 810 is similarly positioned at a predetermined position opened at a predetermined angle by means of a configuration not shown in the drawing. Also, camera 830 can be rotated by means of a mechanism described later-herein, enabling the imaging direction to be changed. Specifically, when imaging a three-dimensional object that does not pass through document feeding apparatus 810 as shown in FIG. 18, document feeding apparatus 810 is set at a predetermined angle, and the direction of camera 830 is set so as to adopt a position facing toward object placement surface 161 (first position). That is to say, in this state, two-dimensional sensor 170 is given the above-described first imaging orientation.

As shown in FIG. 19, document feeding apparatus 810 is composed of a document feed tray 811, a document feed roller 812, document guide rollers 813, document ejection rollers 814, a document ejection tray 815, a document information reading section 816, and so forth. Document ejection tray 815 is positioned opposite document placement platform 160 of apparatus body 101. Above-mentioned camera 830 is attached to this document ejection tray 815.

Sheet documents S placed on document feed tray 811 with the surfaces to be read (hereinafter referred to as “document surfaces”) upward are fed into document feeding apparatus 810 one sheet at a time by the action of document feed roller 812 and a control plate 821. A sheet document S is passed, document surface downward, through document information reading section 816 by means of document guide rollers 813, and is then placed on document ejection tray 815 by means of document ejection rollers 814. A contact glass 822 is provided in document information reading section 816. The document surface of sheet document S passing through in contact with contact glass 822 is irradiated with light by a document-illuminating lamp 823 located beneath contact glass 822. Then light reflected from the document surface of sheet document S reaches camera 830 via a first mirror 824 and a second mirror 825.

As shown in FIG. 20, light reflected from sheet document S to first mirror 824 reaches camera 830 via second mirror 825. At this time, the sheet document S document surface is scanned in the main-scan direction through electrical processing by two-dimensional sensor 170 in camera 830, and further scanned in line order in the sub-scan direction by means of sheet document S movement.

Thus, when sheet document S imaging is performed using the ADF function, camera 830 is set in a position (second position) in which imaging area 170a of two-dimensional sensor 170 is turned in a direction in which part of document information reading section 816 of document feeding apparatus 810 can be scanned via first mirror 824 and second mirror 825. That is to say, with document feeding apparatus 810 closed, camera 830 is rotated in a virtually horizontal direction. In other words, in this state, two-dimensional sensor 170 is given the above-described second imaging orientation.

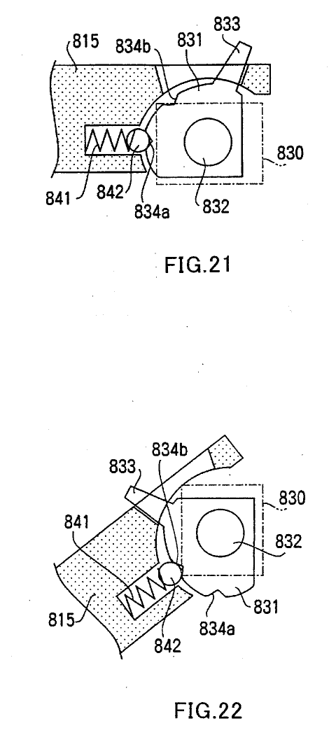

Next, the configuration for setting the above-described first position in which three-dimensional reading is performed, and second position in which ADF reading is performed, will be described using FIG. 20, FIG. 21, and FIG. 22.

FIG. 21 is a schematic configuration diagram showing the configuration of camera 830 in a state in which document feeding apparatus 810 is closed, and FIG. 22 is a schematic configuration diagram showing the configuration of camera 830 in a state in which document feeding apparatus 810 is open.

In FIG. 20, camera 830, together with a cam 831 joined integrally to camera 830, is pivoted so as to be rotatable with respect to document ejection tray 815 about a shaft 832. FIG. 21 and FIG. 22 show cross-sectional drawings of the configuration of camera 830 and its peripheral parts viewed from direction x in FIG. 20.

A sensor lever 833 is attached to cam 831 so as to project from the surface of document ejection tray 815. The user can rotate cam 831 by moving this sensor lever 833. Recesses 834a and 834b are also provided in cam 831. The direction of camera 830 is set securely in the above-described first position and second position by a roller member 842 that is energized by a spring member 841 and fits into recesses 834a and 834b.

Thus, in image forming apparatus 800 of this embodiment, document information of a plurality of sheet documents S can be read (scanned) continuously using two-dimensional sensor 170 for imaging a three-dimensional object, without providing a special-purpose scanner on document feeding apparatus 810.

In this embodiment, a configuration has been described whereby the user manually sets the direction of camera 830 to the first position shown in FIG. 21 and the second position shown in FIG. 22, but it is also possible for the open/closed state of document feeding apparatus 810 to be detected, and the direction of camera 830 to be rotated automatically by means of a motor or the like.

### Embodiment 7

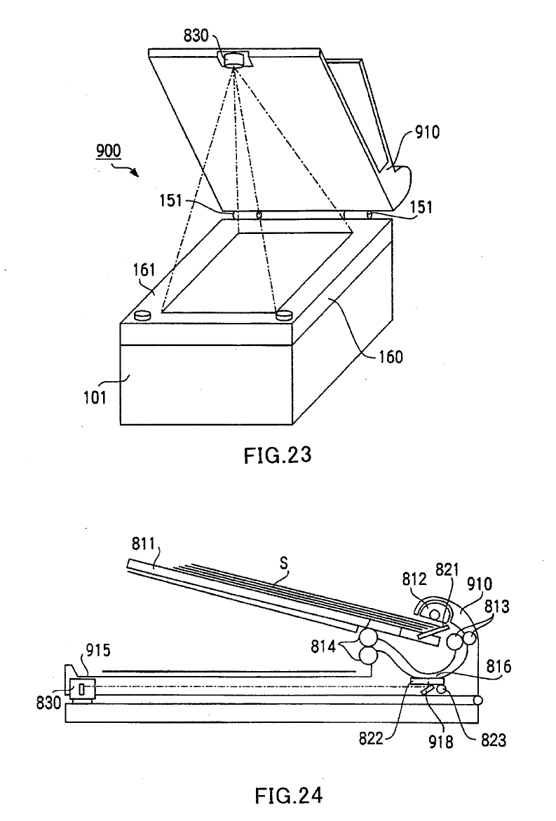

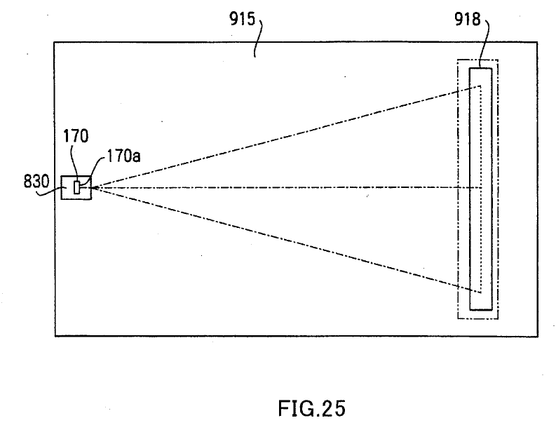

Next, an image forming apparatus according to Embodiment 7 of the present invention will be described with reference to FIG. 23, FIG. 24, and FIG. 25. FIG. 23 is a schematic oblique drawing showing an image forming apparatus according to Embodiment 7 of the present invention in a state in which the document feeding apparatus is open and image information of a three-dimensional object is read, FIG. 24 is a schematic cross-sectional configuration diagram showing an image forming apparatus according to Embodiment 7 of the present invention in a state in which the document feeding apparatus is closed and image information of a sheet document is read, and FIG. 25 is a schematic plan-view configuration diagram showing an image forming apparatus according to Embodiment 7 of the present. invention in a state in which the document feeding apparatus is closed and image information of a sheet document is read.

As shown in FIG. 23 and FIG. 24, an image forming apparatus 900 according to Embodiment 7 of the present invention is equipped with an apparatus body 101, a document placement platform 160, a document feeding apparatus 910, a camera 830, and so forth. Document feeding apparatus 910 can be opened and closed with respect to document placement platform 160 by means of spindles 151, in the same way as in Embodiment 6, but unlike Embodiment 6, spindles 151 are provided on one side of document feeding apparatus 910 orthogonal to the direction of movement of sheet documents S. That is to say, spindles 151 are provided on the document information reading section 816 side of document feeding apparatus 910. Camera 830 is attached to the center part of the opening/closing edge of document ejection tray 915 of document feeding apparatus 910.

In the same way as in Embodiment 6, when the user opens document feeding apparatus 910, document feeding apparatus 910 is lightly locked in position at a predetermined angle by means of a configuration not shown in the drawing. Then camera 830 is directed toward object placement surface 161 as shown in FIG. 23 by user manipulation, and performs imaging. The configuration for setting the position of camera 830 and line-order scanning by two-dimensional sensor 170 are the same as in Embodiment 6.

As shown in FIG. 24, document feeding apparatus 910 has the same configuration as document feeding apparatus 810 of Embodiment 6 with regard to the ADF function. On the other hand, a difference from document feeding apparatus 810 of Embodiment 6 with regard to the optical system is that camera 830 is located on the opposite side of document feeding apparatus 910 to the side on which document information reading section 816 is installed. Also, a reflecting mirror 918 is provided beneath contact glass 822 instead of first mirror 824 and second mirror 825.

In the same way as in Embodiment 6, a sheet document S placed on document feed tray 811 with the document surface upward is fed into document feeding apparatus 810, and after being imaged by camera 830 via document information reading section 816, is placed on document ejection tray 915.

As shown in FIG. 25, light from sheet document S reflected by reflecting mirror 918 reaches camera 830 directly. At this time, the imaging direction of camera 830 is virtually horizontal.

Thus, according to this embodiment, the apparatus configuration can be simplified compared with an image forming apparatus of Embodiment 6, and the apparatus can be made smaller, lighter, and less expensive.

This application is based on Japanese Patent Application No. 2005-245436 filed on Aug. 26, 2005, the entire content of which is expressly incorporated by reference herein.

### INDUSTRIAL APPLICABILITY

An image forming apparatus using an image input apparatus according to the present invention is capable of performing imaging of a three-dimensional object and imaging of a sheet document by means of a small and simple configuration, and is therefore suitable for use as an image forming apparatus such as a monochrome or color copier, printer, or facsimile machine that employs an image forming method such as electrophotography, electrostatic recording, ionography, or magnetic recording.

1. An image input apparatus comprising:
a document transportation section that moves a sheet document one sheet at a time and passes the sheet document through a predetermined area for imaging; and
a two-dimensional sensor that images the sheet document appearing in the predetermined area on a partial area of an imaging area thereof.

2. The image input apparatus according to claim 1, further comprising:
a sensor deployment section that deploys the two-dimensional sensor so as to be switchable between a first imaging orientation whereby an image of an imaging object positioned in an area other than the predetermined area is captured in an entire area of the imaging area, and a second imaging orientation whereby an image of a sheet document appearing in the predetermined area is captured in a partial area of the imaging area; and
an imaging control section that reads an image captured in the entire area of the imaging area when the two-dimensional sensor has the first imaging orientation, and reads an image captured in a partial area of the imaging area when the two-dimensional sensor has the second imaging orientation.

3. The image input apparatus according to claim 2, wherein the first imaging orientation is an orientation whereby an image of an imaging object placed on a document placement platform with which the image input apparatus is equipped is captured in the entire area of the imaging area.

4. The image input apparatus according to claim 2, wherein the imaging control section, when the two-dimensional sensor has the second imaging orientation, performs reading of an image of a sheet document that passes the predetermined area by repeating imaging in a partial area of the imaging area in the two-dimensional sensor in synchronization with a speed at which a sheet document passes the predetermined area, and combining an obtained plurality of captured images.

5. The image input apparatus according to claim 2, wherein the imaging control section, when the two-dimensional sensor has the second imaging orientation, performs reading of an image of a sheet document that passes the predetermined area by repeating acquisition of images captured in a partial area of the imaging area from the two-dimensional sensor in synchronization with a speed at which a sheet document passes the predetermined area, and combining an obtained plurality of captured images.

6. The image input apparatus according to claim 3, wherein:
the two-dimensional sensor having the first imaging orientation is positioned above the document placement platform;
the sensor deployment section has a sensor supporting section that supports the two-dimensional sensor; and
the second imaging orientation is an orientation whereby an image from the predetermined area configured in the sensor supporting section is captured in a partial area of the imaging area.

7. The image input apparatus according to claim 6, wherein the sensor deployment section has the sensor supporting section installed so as to able to be opened and closed with respect to the document placement platform, and deploys the two-dimensional sensor in the first imaging orientation when the sensor supporting section is open with respect to the document placement platform, and deploys the two-dimensional sensor in the second imaging orientation when the sensor supporting section is closed with respect to the document placement platform.

8. The image input apparatus according to claim 7, wherein the two-dimensional sensor is located on an opening/closing edge with respect to the document placement platform of the sensor supporting section.

9. The image input apparatus according to claim 7, wherein the document transportation section is installed in the sensor supporting section.

10. The image input apparatus according to claim 7, further comprising an open/closed detection section that detects an open/closed state of the sensor supporting section with respect to the document placement platform,
wherein the sensor deployment section has a direction switching section that switches a direction of the imaging area of the two-dimensional sensor between a direction in the first imaging orientation and a direction in the second imaging orientation according to a detection result of the open/closed detection section.

11. The image input apparatus according to claim 2, further comprising a document movement detection section that detects movement of a sheet document in the predetermined area based on an image captured by the two-dimensional sensor when the two-dimensional sensor has the second imaging orientation.

12. The image input apparatus according to claim 4, wherein the second imaging orientation is an orientation whereby images appearing in the predetermined area and an adjacent area thereto in a direction of movement of a sheet document are captured on the imaging area,
further comprising a synchronization determination section that determines whether or not an image is synchronized with a speed at which a sheet document passes the predetermined area by means of the imaging control section based on an image part corresponding to the adjacent area in a captured image when the two-dimensional sensor has the second imaging orientation.

13. The image input apparatus according to claim 1, wherein the two-dimensional sensor has a mode switching section that switches between a mode in which only an image captured in a partial area of the imaging area is captured, and a mode in which an image captured in an entire area of the imaging area is captured.

14. The image input apparatus according to claim 6, wherein the sensor supporting section has a tray on which a sheet document for which imaging has been performed by the two-dimensional sensor is placed in a state in which the sensor supporting section is closed with respect to the document placement platform.

15. The image input apparatus according to claim 2, wherein, when the two-dimensional sensor has the second imaging orientation, a size of an image of the predetermined area captured on the imaging area is variable.

16. The image input apparatus according to claim 2, wherein the two-dimensional sensor is a shorter distance from the predetermined area when having the second imaging orientation than when having the first imaging orientation.

17. An image forming apparatus comprising:
the image input apparatus according to claim 7; and
an image forming section that forms an image based on an image captured by the image input apparatus.

18. The image forming apparatus according to claim 17, further comprising a paper ejection section that ejects printing paper on which an image has been formed by the image forming section onto a top surface of an apparatus body equipped with the image input apparatus and the image forming section,
wherein the sensor supporting section has a top-surface paper ejection tray on which printing paper ejected by the paper ejection section is placed in a state in which the sensor supporting section is closed with respect to the document placement platform.

19. The image forming apparatus according to claim 17, wherein the document transportation section:
has a manual feed tray for holding a manually fed sheet supplied to the apparatus body; and
switches between a mode in which a sheet placed on the manual feed tray is moved and passed through the predetermined area one sheet at a time as a sheet document, and a mode in which a sheet placed on the manual feed tray is sent one sheet at a time to the image forming section as paper on which image forming is to be performed.

20. The image forming apparatus according to claim 18, further comprising:
an intra-body tray located in a mid-section of the apparatus body; and
a paper presence/absence determination section that determines whether or not a sheet has been placed on the top-surface paper ejection tray,
wherein the paper ejection section, when a sheet has been placed on the top-surface paper ejection tray, ejects printing paper on which an image has been formed by the image forming section onto the intra-body tray.

21. The image forming apparatus according to claim 18, further comprising:
an intra-body tray located in a mid-section of the apparatus body; and
an open/closed detection section that detects the open/closed state of the sensor supporting section with respect to the document placement platform,
wherein the paper ejection section, when the sensor supporting section is open with respect to the document placement platform, ejects printing paper on which an image has been formed by the image forming section onto the intra-body tray.

22. The image forming apparatus according to claim 17, wherein:
the predetermined area is configured inside the apparatus body, and
the document feed section comprises:
a document feed tray for holding a manually fed sheet document, provided on a side of the apparatus body;
a document moving section whereby a sheet placed on the document feed tray is moved and passed through the predetermined area one sheet at a time, and ejected at a side of the apparatus body; and
a document ejection tray that holds a sheet document ejected by the document moving section, provided on a side of the apparatus body.
